(19) United States
(12) Patent Application Publication
(10) Pub. No.: US 2016/0070210 A1
(43) Pub. Date: Mar. 10, 2016

(54) ENDLESS BELT, TRANSFER UNIT, AND IMAGE FORMING APPARATUS

(71) Applicant: Fuji Xerox Co., Ltd., Tokyo (JP)

(72) Inventor: Masayuki SEKO, Kanagawa (JP)

(21) Appl. No.: 14/607,842

(22) Filed: Jan. 28, 2015

(30) Foreign Application Priority Data
Sep. 10, 2014 (JP) 2014-184452

(51) Int. Cl. G03G 15/16

(52) U.S. Cl. CPC G03G 15/162

(57) ABSTRACT

An endless belt includes an endless belt base material, and a belt meandering suppression member that has a belt shape and is disposed in a circumferential direction of at least one end portion of the belt base material in a width direction, wherein a value obtained by subtracting a linear thermal expansion coefficient of the belt meandering suppression member from a linear thermal expansion coefficient of the belt base material is from −1×10⁻⁵/° C. to 20×10⁻⁵/° C., and a tensile stress of the belt meandering suppression member at a 300% elongation is equal to or more than 5 MPa.

### CROSS-REFERENCE TO RELATED APPLICATIONS

This application is based on and claims priority under 35 USC 119 from Japanese Patent Application No. 2014-184452 filed Sep. 10, 2014.

### BACKGROUND

1. Technical Field

The invention relates to an endless belt, a transfer unit, and an image forming apparatus.

2. Related Art

An image forming apparatus using an electrostatic copying type method makes a surface of an electrophotographic photoreceptor to be charged and forms an electrostatic latent image by using laser beams each modulated corresponding to an image signal. Then, the image forming apparatus develops the electrostatic latent image with a charged toner to form a visible toner image and electrostatically transfers the toner image to a recording medium such as a paper. Then, the image forming apparatus applies heat and pressure to the recording medium to fix the image.

In an image forming apparatus forming a color image, plural image forming units for forming toner images with color components different from each other are disposed. The toner images formed in the image forming unit are primarily transferred to, for example, an intermediate transfer belt in consecutive order and are superimposed thereon. Then, the superimposed image is secondarily transferred to a recording medium from the intermediate transfer belt.

Meanwhile, an image forming apparatus forming a monochrome image uses a method in which a toner image formed on a surface of an electrophotographic photoreceptor is primarily transferred to a transfer belt and then secondarily transferred to a recording medium, in addition to a method in which a toner image formed on a surface of an electrophotographic photoreceptor is directly transferred to a recording medium.

In the method in which the toner image is transferred to the recording medium through the transfer belt, the transfer belt rotates in a circumferential direction thereof in a state where the transfer belt is supported by plural rolls. In addition, various measures for preventing belt meandering due to displacement of the transfer belt in an axis direction of the support rolls have been proposed.

### SUMMARY

According to an aspect of the invention, there is provided an endless belt including:

an endless belt base material; and

a belt meandering suppression member that has a belt shape and is disposed in a circumferential direction of at least one end portion of the belt base material in a width direction,

wherein a value obtained by subtracting a linear thermal expansion coefficient of the belt meandering suppression member from a linear thermal expansion coefficient of the belt base material is from −1×10⁻⁵/° C. to 20×10⁻⁵/° C., and

a tensile stress of the belt meandering suppression member at a 300% elongation is equal to or more than 5 MPa.

### BRIEF DESCRIPTION OF THE DRAWINGS

Exemplary embodiments of the present invention will be described in detail based on the following figures, wherein:

FIG. 1 is a schematic diagram illustrating an example of a configuration of an endless belt according to an exemplary embodiment;

FIG. 2 is a schematic diagram illustrating an example of a configuration of a transfer unit according to the exemplary embodiment;

FIG. 3 is a partial cross-sectional view illustrating the example of the configuration of the transfer unit according to the exemplary embodiment; and

FIG. 4 is a schematic diagram illustrating an example of a configuration of an image forming apparatus according to the exemplary embodiment.

### DETAILED DESCRIPTION

Hereinafter, an exemplary embodiment of the invention will be described in detail with reference to the accompanying drawings. Members having a common function and a common effect are denoted by the same reference numerals in all the drawings and the descriptions thereof will be omitted in some cases.

Endless Belt

An endless belt according to the exemplary embodiment includes an endless belt base material and a belt meandering suppression member that has a belt shape and is disposed in a circumferential direction of at least one end portion of the belt base material in a width direction. In the endless belt, a value obtained by subtracting a linear thermal expansion coefficient of the belt meandering suppression member from a linear thermal expansion coefficient of the belt base material is from −1×10⁻⁵/° C. to 20×10⁻⁵/° C., and a tensile stress of the belt meandering suppression member is equal to or more than 5 MPa at 300% elongation.

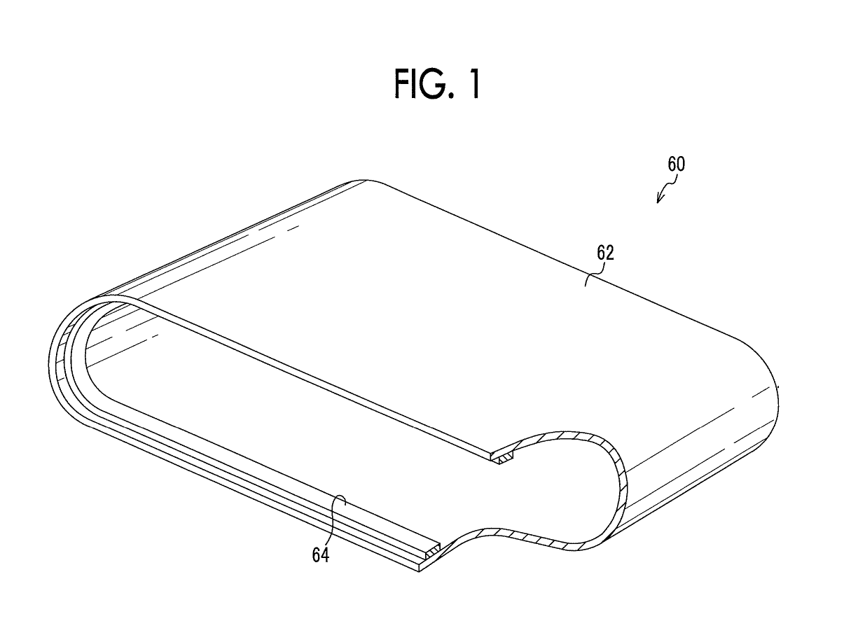

FIG. 1 is a schematic diagram illustrating an example of a configuration of the endless belt according to the exemplary embodiment. Some portions in FIG. 1 illustrate a partial cross-section. An endless belt 60 according to the exemplary embodiment includes an endless belt base material 62 and a belt meandering suppression member 64 that has a belt shape and is disposed on an inner circumference surface side along an end portion of the belt base material 62 in a width direction of the belt base material 62.

When color images are formed sequentially particularly at high temperature and high humidity even in the use of the transfer belt in which the belt meandering suppression members are provided along the entire circumference of the belt base material on the inner circumference surface side of at least one end portion of the belt base material in order to suppress meandering of the transfer belt, color deviation may occur. It is considered that the color deviation results from the belt meandering suppression member being separated from the transfer belt, and belt meandering of the transfer belt cannot be prevented, and when colors are superimposed on the transfer belt, an image formation position for each color is shifted. The separation of the belt meandering suppression member from the transfer belt occurs due to stress applied by deformation of the belt meandering suppression member which is caused by rolls and the like. Even though the belt meandering suppression member is not separated, the belt meandering suppression member is deformed to have a trumpet shape of which the diameter in an end portion of the belt in which the belt meandering suppression member is provided becomes wide or the belt meandering suppression member is deformed to have a narrow diameter in the end portion of the belt thereby causing wrinkles to occur. Thus, the color deviation may occur easily.

If the endless belt according to the exemplary embodiment is used as a transfer belt, position shift of a toner image is prevented from occurring. In addition, color deviation is prevented from occurring when a color image is formed. The reasons are considered as follows.

Since a difference between a linear thermal expansion coefficient of the belt base material and a linear thermal expansion coefficient of the belt meandering suppression member is in a specified range, it is difficult that deformation of the belt or separation of the belt meandering suppression member occurs due to the difference in thermal expansion between the belt base material and the belt meandering suppression member in the endless belt according to the exemplary embodiment. Since the tensile stress of the belt meandering suppression member at 300% elongation is relatively high, it is also difficult for the belt meandering suppression member to be extended and deformed at high temperature and high humidity. Accordingly, if the endless belt according to the exemplary embodiment is used as the transfer belt, position shift of a toner image can be prevented from occurring.

The belt base material and the belt meandering suppression member that constitute the endless belt according to the exemplary embodiment will be described specifically.

Belt Base Material

The belt base material is formed with an endless shape and contains resin. The belt base material may be a single layer or may have a structure in which two or more layers are laminated.

Linear Thermal Expansion Coefficient

The belt base material is configured in such a manner that a value obtained by subtracting the linear thermal expansion coefficient of the belt meandering suppression member from the linear thermal expansion coefficient of the belt base material is from −1×10⁻⁵/° C. to 20×10⁻⁵/° C. The value obtained by subtracting the linear thermal expansion coefficient of the belt meandering suppression member from the linear thermal expansion coefficient of the belt base material is preferably from −1×10⁻⁵/° C. to 15×10⁻⁵/° C. The value is more preferably from 0×10⁻⁵/° C. to 10×10⁻⁵/° C.

The linear thermal expansion coefficient of the belt base material may be changed depending on the linear thermal expansion coefficient of the belt meandering suppression member. However, in view of rotating the belt base material by rotation of a driving roll, the linear thermal expansion coefficient of the belt base material is preferably equal to or less than 60×10⁻⁵/° C., and more preferably equal to or less than 45×10⁻⁵/° C.

The linear thermal expansion coefficients of the belt base material and the belt meandering suppression member in the exemplary embodiment are measured with a thermal mechanical analysis apparatus (manufactured by Hitachi High-Tech Science Corporation) by using a method of JIS K7197.

Examples of the resin forming the belt base material include polyimide resin, fluorinated polyimide resin, polyamide resin, polyamideimide resin, polyether ether ester resin, polyarylate resin, and polyester resin. As the resin forming the belt base material, polyimide and polyamideimide are preferable.

Polyimide Resin

As polyimide resin capable of forming the belt base material, for example, an imidization material of polyamic acid which is a polymer of tetracarboxylic acid dianhydride and a diamine compound is included. Specifically, examples of polyimide resin include a substance which is obtained by polymerizing equimolecular amounts of tetracarboxylic acid dianhydride and the diamine compound in a solvent to obtain a polyamic acid solution and imidizing the polyamic acid.

As tetracarboxylic acid dianhydride, materials represented by, for example, the following formula (I) are included.

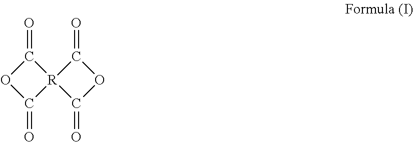

In the formula (I), R refers to a tetravalent organic group which includes aromatic group, aliphatic group, alicyclic group, group obtained by combining aromatic group and aliphatic group or a group obtained by performing substitution with respect to these groups.

Examples of tetracarboxylic acid dianhydride, specifically include, pyromellitic acid dianhydride, 3,3′,4,4′-benzophenone tetracarboxylic acid dianhydride, 3,3′,4,4′-biphenyl tetracarboxylic acid dianhydride, 2,3,3′,4-biphenyl tetracarboxylic acid dianhydride, 2,3,6,7-naphthalene tetracarboxylic acid dianhydride, 1,2,5,6-naphthalene tetracarboxylic acid dianhydride, 1,4,5,8-naphthalene tetracarboxylic acid dianhydride, 2,2′-bis(3,4-dicarboxy phenyl) sulfonic acid dianhydride, perylene-3,4,9,10-tetracarboxylic acid dianhydride, bis(3,4-dicarboxy phenyl) ether dianhydride, and ethylene tetracarboxylic acid dianhydride.

Specific examples of the diamine compound include, 4,4′-diaminodiphenyl ether, 4,4′-diaminodiphenyl methane, 3,3′-diaminodiphenyl methane, 3,3′-dichlorobenzidine, 4,4′-diaminodiphenyl sulfide, 3,3′-diaminodiphenyl sulfone, 1,5-diamino naphthalene, m-phenylene diamine, p-phenylene diamine, 3,3′-dimethyl 4,4′-biphenyl diamine, benzidine, 3,3′-dimethyl benzidine, 3,3′-dimethoxy benzidine, 4,4′-diaminodiphenyl sulfone, 4,4′-diaminodiphenyl propane, 2,4-bis(β-amino-tert-butyl)toluene, bis(p-β-amino-tert-butylphenyl) ether, bis(p-β-methyl-δ-aminophenyl)benzene, bis-p-(1,1-dimethyl-5-amino-pentyl)benzene, 1-isopropyl-2,4-m-phenylenediamine, m-xylylenediamine, p-xylylenediamine, di(p-aminocyclohexyl) methane, hexamethylenediamine, heptamethylenediamine, octamethylenediamine, nonamethylenediamine, decamethylenediamine, diaminopropyl tetramethylene, 3-methylheptamethylene diamine, 4,4-dimethyl heptamethylene diamine, 2,11-diaminododecane, 1,2-bis-3-aminopropoxy ethane, 2,2-dimethylpropylene diamine, 3-methoxyhexamethylene diamine, 2,5-dimethyl heptamethylene diamine, 3-methylheptamethylene diamine, 5-methylnonamethylene diamine, 2,17-diamino eicosadecane, 1,4-diaminocyclohexane, 1,10-diamino-1,10-dimethyldecane, 12-diamino octadecane, 2,2-bis[4-(4-aminophenoxy)phenyl]propane, piperazine, H₂N(CH₂)₃O(CH₂)₂O(CH₂)NH₂, H₂N(CH₂)₃S(CH₂)₃NH₂, and H₂N(CH₂)₃N(CH₃)₂(CH₂)₃NH₂.

As a solvent used when tetracarboxylic acid dianhydride and diamine are polymerized, for example, a polar solvent (organic polar solvent) is appropriately included in view of solubility and the like. As the polar solvent, for example, N,N-dialkyl amides is preferable. Specifically, examples of the polar solvent have small molecular weight and include N,N-dimethylformamide, N,N-dimethyl acetamide, N,N-diethylformamide, N,N-diethyl acetamide, N,N-dimethyl methoxyacetamide, dimethyl sulfoxide, hexamethylphosphortriamide, N-methyl-2-pyrrolidone, pyridine, tetramethylene sulfone, and dimethyl tetramethylene sulfone. The solvent may be obtained by using only one type among these compounds or be obtained by using two or more types together.

Polyamideimide Resin

Polyamideimide resin capable of forming the belt base material is a resin having an imide group and an amide group in the molecule, and those having a generally known structure may be used. As a synthetic method of polyamide-imide resin, an acid chloride method, an isocyanate method, and the like have been known and any one of these methods may be used. In view of stability of polyamideimide resin solution to be obtained, the isocyanate method is preferable.

The isocyanate method is a method in which an anhydrous carboxylic acid compound is allowed to react with a diisocyanate compound. The acid chloride method is a method in which a carboxylic acid chloride compound is allowed to react with a diamine compound. The anhydrous carboxylic acid compound and the carboxylic acid chloride compound are referred to as “carboxylic acid component” below in some case.

As the anhydrous carboxylic acid compound, trimellitic acid anhydride or derivatives of trimellitic acid anhydride is preferable. An anhydrous carboxylic acid compound (for example, dicarboxylic acid anhydride, tetracarboxylic acid anhydride, and the like) which reacts with an isocyanate group or an amino group may be used together in addition to trimellitic acid anhydride or derivatives thereof.

The diisocyanate compound is represented by the following formula (II).

O═C═N—R—N═C═O Formula (II)

In the formula (II), R refers to a bivalent aromatic group or a bivalent aliphatic group.

As specific examples of the diisocyanate compound, the following compounds may be included. As the diisocyanate compound, only one type of compound among the following compounds may be used or two or more types of compound may be used together.

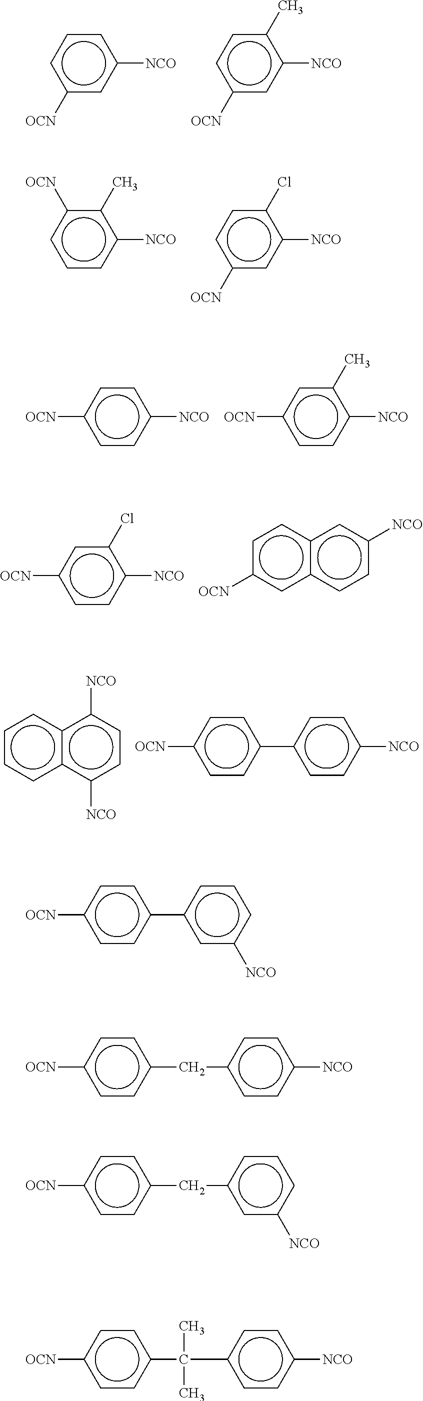

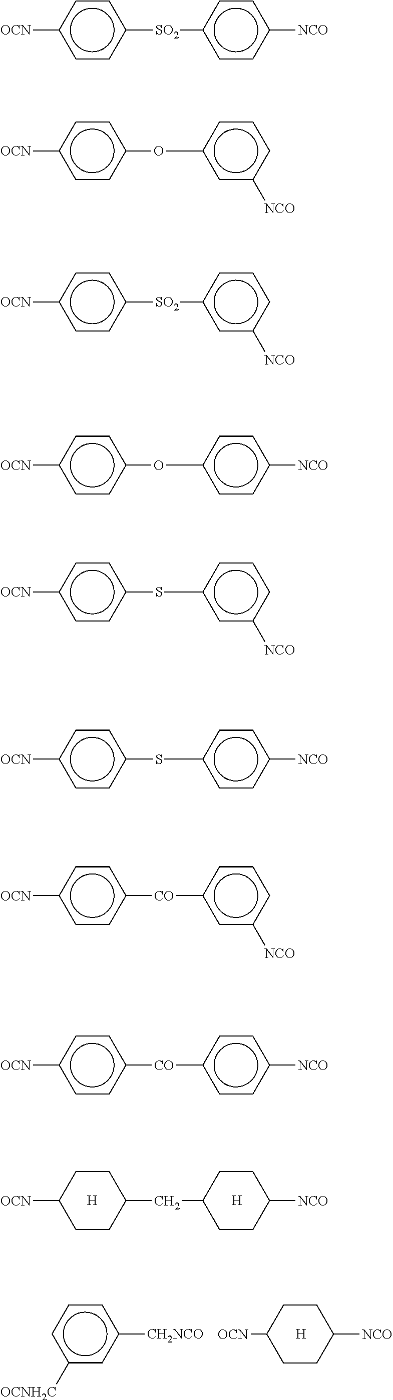

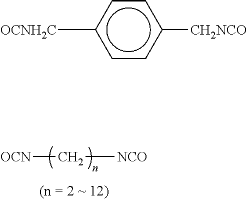

As the carboxylic acid chloride compound, trimellitic acid chloride or chloride of derivatives of trimellitic acid chloride may be included. Dicarboxylic acid chloride, tetracarboxylic chloride, and the like may be used or two or more type of compounds among these compounds may be used together, in addition to trimellitic acid chloride or chloride of derivatives thereof.

Examples of the diamine compound include aliphatic diamine such as ethylene diamine, propylene diamine, and hexamethylene diamine; alicyclic diamine such as 1,4-cyclohexane diamine, 1,3-cyclohexane diamine, isophorone diamine, and 4,4′-diaminodicyclohexylmethane; and aromatic diamine such as m-phenylene diamine, p-phenylene diamine, 4,4′-diaminodiphenyl methane, 4,4′-diaminodiphenyl ether, 4,4′-diaminodiphenyl sulfone, benzidine, o-tolidine, 2,4-tolylenediamine, 2,6-tolylenediamine, and xylylene diamine. Among these compounds, 4,4′-diaminodiphenyl methane, isophorone diamine, and 4,4′-diamino dicyclohexyl methane are preferable in terms of thermal resistance, mechanical characteristics, solubility, and the like.

Regarding mixing ratio of an isocyanate compound or the diamine compound with a carboxylic acid component, it is preferable that a ratio of the total molar number of an isocyanate group or an amino group to the total molar number of a carboxyl group and an acid anhydride group in an acid component be from 0.6 to 1.4. It is more preferable that the ratio is from 0.7 to 1.3. Further, it is particularly preferable that the ratio is from 0.8 to 1.2.

As a manufacturing method of polyamideimide resin using the isocyanate method, specifically the following methods may be included.

1) a method: an isocyanate component and a tricarboxylic acid component are used once, and allowed to react with each other and thus polyamideimide resin is obtained.

2) a method: a surplus amount of an isocyanate component and an acid component are allowed to react with each other and synthesized to obtain amide imide oligomer which has an isocyanate group on an end. Then a tricarboxylic acid component is added to the amide imide oligomer and is allowed to react with the amide imide oligomer. Thus, polyamideimide resin is obtained.

3) a method: a surplus amount of a tricarboxylic acid component and an isocyanate component are allowed to react with each other and synthesized to obtain amide imide oligomer which has a carboxylic acid or an acid anhydride group on an end. Then an acid component and an isocyanate component are added to the amide imide oligomer and allowed to react with the amide imide oligomer. Thus, polyamideimide resin is obtained.

In the manufacturing method of polyamideimide resin, the amidation reaction and the imidization reaction may be simultaneously performed, or the imidization reaction may be performed after the amidation reaction is completed.

The belt base material according to the exemplary embodiment may contain two or more types of resins and may be manufactured using a resin coming into the market. For example, in examples which will be described later, a product used in manufacturing of the belt base material will be described.

The belt base material according to the exemplary embodiment may be configured to contain materials other than a resin. For example, the belt base material may contain a conductive material such as a carbon black, an antioxidant, a surfactant, and particles of polytetrafluoroethylene (PTFE), SiO₂, and the like.

When, for example, the endless belt according to the exemplary embodiment is used as an intermediate transfer belt, it is preferable that the belt base material have a thickness of from 0.02 mm to 0.2 mm.

The method of manufacturing the belt base material according to the exemplary embodiment is not particularly limited and the belt base material may be manufactured depending on use. In the following description, a manufacturing method of the belt base material which contains carbon black as the conductive material and polyimide resin as a resin material will be described, but it is not limited thereto.

First, a core is prepared. As the core to be prepared, a cylindrical mold or the like is included. As a material of the core, for example, metal such as aluminium, stainless steel, and nickel is included. It is necessary that the core has a length equal to or longer than the length of a belt base material which is a target. It is preferable that the core have a length longer than the length of the belt base material which is a target by from 10% to 40% of the length of the belt base material.

As coating liquid for manufacturing the belt base material, a polyamic acid solution in which carbon black is dispersed is prepared.

Specifically, for example, tetracarboxylic acid dianhydride and a diamine compound are dissolved in an organic polar solvent. Carbon black is dispersed in the organic polar solvent and then is polymerized to prepare a polyamic acid solution in which carbon black is dispersed.

In preparing the polyamic acid solution, monomer concentration (concentration of tetracarboxylic acid dianhydride and the diamine compound in the solvent) is set in accordance with various conditions. It is preferable that the monomer concentration be from 5% by weight to 30% by weight. It is preferable that temperature in polymerization be set to be equal to or less than 80° C. It is particularly preferable that the temperature in polymerization be set to be from 5° C. to 50° C. The polymerization is performed for from five hours to ten hours.

Then, the cylindrical mold as the core is coated with the coating liquid for manufacturing the belt base material to form a coating layer.

A coating method with the coating liquid on the cylindrical mold is not particularly limited. For example, the following methods are included: a method in which an outer circumference surface of the cylindrical mold is dipped in the coating liquid; a method in which an inner circumference surface of the cylindrical mold is coated with the coating liquid; and a method in which the outer circumference surface or the inner circumference surface is coated with the coating liquid by using a “spiral coating method” or a “die type coating method” while an axis of the cylindrical mold is placed horizontally and the cylindrical mold is rotated.

The coating layer formed with the coating liquid for manufacturing the belt base material is dried to form a film (dried coating layer before imidization). A drying condition may be, for example, temperature of from 80° C. to 200° C. and a time period of from 10 minutes to 60 minutes. The heating time period may become short as the temperature increases. In heating, blowing of hot air may be applied. In heating, the temperature may increase stepwise or may increase gradually at a constant rate. The axis direction of the core may be placed horizontally and the core may be rotated at from 5 rpm to 60 rpm. After the core is dried, the core may be placed vertically.

Then, imidization processing (firing) is performed on the film.

The film is heated, for example, at temperature of from 250° C. to 450° C. (preferably from 300° C. to 350° C.) for from 20 minutes to 60 minutes as a processing (firing) condition of imidization and thus the imidization reaction occurs and a polyimide resin film is formed. In heating reaction, the temperature may increase stepwise or increase continuously and gradually before the temperature reaches the final temperature.

After the imidization processing, the film (polyimide resin film) is taken out from the core. Accordingly, the belt base material is obtained.

The linear thermal expansion coefficient of the belt base material is determined almost by properties of a resin to be contained, but may be adjusted by, for example, the concentration of the conductive material (carbon black). Specifically, the linear thermal expansion coefficient of the belt base material tends to increase if a mixture concentration becomes low and tends to decrease if the mixture concentration becomes high.

Belt Meandering Suppression Member

The belt meandering suppression member 64 has, for example, a belt shape in which a cross-section in a thickness direction is rectangular. The belt meandering suppression member 64 is disposed along the circumferential direction on the inner circumference surface side of an end portion of the belt base material 62.

The belt meandering suppression member is configured in such a manner that the value obtained by subtracting the linear thermal expansion coefficient of the belt meandering suppression member from the linear thermal expansion coefficient of the belt base material is from −1×10⁻⁵/° C. to 20×10⁻⁵/° C. and the tensile stress of the belt meandering suppression member at 300% elongation is equal to or more than 5 MPa.

Linear Thermal Expansion Coefficient

The linear thermal expansion coefficient of the belt meandering suppression member is preferably equal to or less than 60×10⁻⁵/° C. and more preferably equal to or less than 45×10⁻⁵/° C. from a relationship of the belt meandering suppression member and the belt base material.

Tensile Stress at 300% Elongation

The tensile stress of the belt meandering suppression member at 300% elongation is equal to or more than 5 MPa. In view of a follow-up property of the belt, the linear thermal expansion coefficient of the belt meandering suppression member is preferably from 5 MPa to 30 MPa and more preferably from 5 MPa to 20 MPa.

The tensile stress of the belt meandering suppression member at 300% elongation is measured with a tension tester (manufactured by Toyo Seiki Seisaku-sho, Ltd.) by using a method of JIS K6251.

It is preferable that the belt meandering suppression member be formed of an elastic material. As a material capable of forming the belt meandering suppression member, for example, an elastic member having appropriate hardness such as polyurethane rubber, neoprene rubber, polyurethane rubber, silicone rubber, polyester elastomer, chloroprene rubber, and nitrile rubber is included. Among these, polyurethane rubber, silicone rubber, and polyester elastomer are preferable and polyester ether elastomer is more preferable in view of an electric insulation property, moisture resistance, solvent resistance, ozone resistance, thermal resistance, abrasion resistance, manufacturing availability, and the like in addition to the linear thermal expansion coefficient and the tensile stress.

The belt meandering suppression member has a belt shape and the width, the thickness, and the like thereof may be determined depending on a use condition of the endless belt and the like. In view of a belt meandering prevention effect, durability, and the like, it is preferable that the width of the belt meandering suppression member be from 1 mm to 10 mm and it is particularly preferable that the width of the belt meandering suppression member be from 4 mm to 7 mm.

The thickness of the belt meandering suppression member is not particularly limited. In view of a belt meandering suppression effect, durability, and the like, it is preferable that the thickness of the belt meandering suppression member be from 1 mm to 5 mm and it is more preferable that the thickness of the belt meandering suppression member be from 3 mm to 5 mm.

A position of the belt meandering suppression member 64 (distance from a side edge of the belt base material) in the end portion of the belt base material 62 may be set in accordance with use and a function of the endless belt 60, and an apparatus to which the endless belt is applied, and the like. The belt meandering suppression member 64 may be provided in such a manner that an end surface thereof is flush with an end surface of the belt base material 62 in a width direction.

It is preferable that the belt meandering suppression member 64 is provided sequentially on the entire circumference of the belt base material 62. Plural belt meandering suppression members 64 may be also provided intermittently along the entire circumference of the belt base material.

In the endless belt illustrated in FIG. 1, the belt meandering suppression member 64 is provided on only an end portion side of the belt base material 62 in the width direction. However, the belt meandering suppression members 64 may be provided along the circumferential direction on both end portions.

In the endless belt illustrated in FIG. 1, the belt meandering suppression member 64 is provided on the inner circumference surface side of the belt base material 62. However, the belt meandering suppression member 64 may be disposed on the outer circumference surface side of the belt base material 62 depending on use of applying the endless belt 60.

The belt meandering suppression member 64 may be formed integrally with the belt base material 62 or may adhere to the belt base material 62 with adhesive. As the adhesive, well-known adhesives may be applied.

Elastic Adhesive

Examples of the adhesive may include Super-XNo8008 (manufactured by Cemedine Co., Ltd.) which is formed of acrylic modified silicone polymer as a main component, Sciflex 100 (manufactured by Konishi Co., Ltd.) which is formed of special modified silicone polymer as a main component, and the like. In terms of adhesive strength to the belt base material, Super-XNo8008 (manufactured by Cemedine Co., Ltd.) which is formed of acrylic denatured silicone polymer as a main component is more preferably used.

Thermal Sensitive Adhesive Sheet

A thermal sensitive adhesive sheet is not particularly limited as long as the thermal sensitive adhesive sheet has an excellent adhesive property between the belt base material 62 and the belt meandering suppression member 64. As the thermal sensitive adhesive sheet, an adhesive sheet formed of a resin based material as a main component may be used and the resin based material includes, for example, acrylic material, silicone material, natural or synthetic rubber material, urethane material, synthetic resin material such as copolymer of vinyl chloride and vinyl acetate.

Specifically, polyester adhesive sheets GM-913 and GM-920 (manufactured by Toyobo Co., Ltd.), a polyester adhesive sheet D3600 (manufactured by Sony Chemical Corp.), and the like may be included. In terms of adhesive strength to the belt base material 62, the polyester adhesive sheet D3600 (manufactured by Sony Chemical Corp.) and the polyester adhesive sheet GM-920 (manufactured by Toyobo Co., Ltd.) are preferably used.

An adhesive layer which uses an elastic adhesive or a thermal sensitive adhesive sheet has a thickness of preferably from 0.01 mm to 0.3 mm, and a thickness of more preferably from 0.02 mm to 0.05 mm. If the thickness of the adhesive layer is equal to or more than 0.01 mm, it is likely to obtain high adhesive strength with uniformity. If the thickness of the adhesive layer is equal to or less than 0.3 mm, position shift of the belt meandering suppression member 64 due to adhesion unevenness is prevented.

Transfer Unit

A transfer unit according to the exemplary embodiment includes the endless belt according to the exemplary embodiment and plural rolls. The plural rolls includes at least one roll which contacts the belt meandering suppression member of the endless belt and thus suppresses movement of the endless belt in the width direction of the endless belt and the plural rolls rotatably support the endless belt.

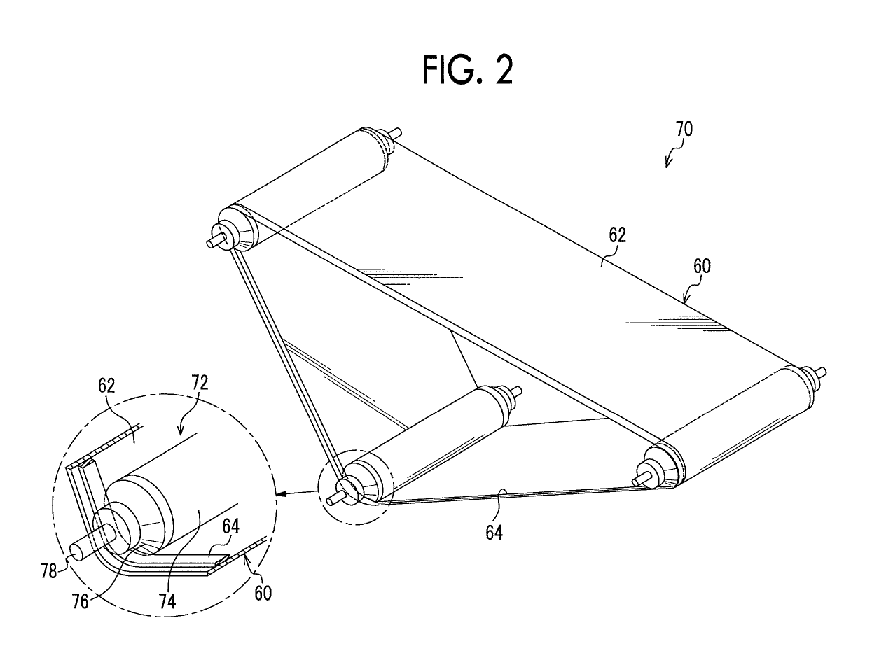

FIG. 2 is a schematic configuration diagram illustrating an example of a configuration of the transfer unit according to the exemplary embodiment.

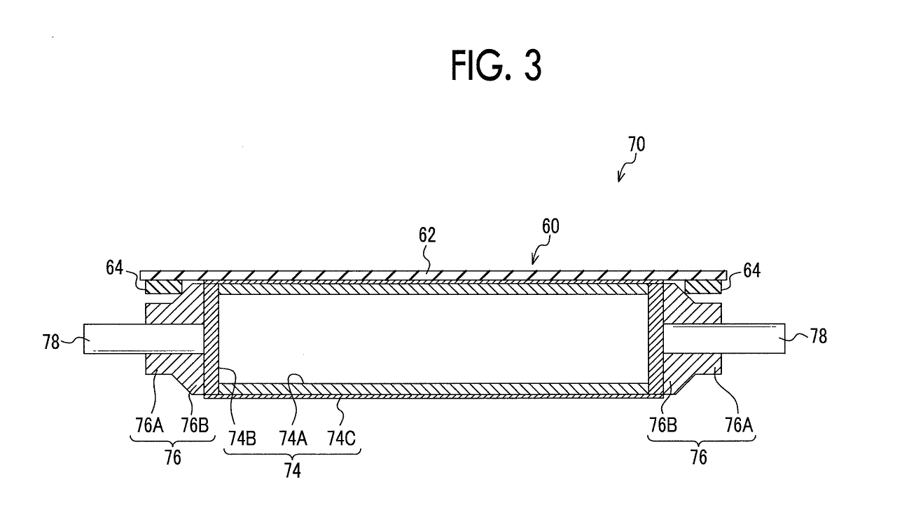

FIG. 3 is a partial cross-sectional view illustrating an example of the configuration of the transfer unit according to the exemplary embodiment. In the transfer unit in FIG. 3, the belt meandering suppression members each is provided on the inner circumference surface side of the belt base material in both end portions of the belt base material.

The transfer unit 70 includes the endless belt 60 according to the exemplary embodiment and a guide attachment support roll 72. The guide attachment support roll 72 is provided to contact the inner circumference surface of the endless belt 60 and rotatably supports the endless belt 60. The guide attachment support roll 72 includes a belt meandering suppression member guide 76 (regulating member). The belt meandering suppression member guide 76 contacts the belt meandering suppression member 64 of the endless belt 60 and thus suppresses movement of the endless belt 60 in the width direction of the endless belt 60. The transfer unit illustrated in FIG. 2 includes three guide attachment support rolls 72. However, the number of the rolls 72 is not particularly limited as long as at least one of support rolls includes one or more support rolls 72 which are the guide attachment support rolls.

The guide attachment support roll 72 includes a support roll 74, the belt meandering suppression member guide 76 (regulating member), and a shaft 78. The support roll 74 contacts the inner circumference surface of the endless belt 60. The belt meandering suppression member guide 76 is provided on both end portions of the support roll 74 in an axis direction of the support roll 74. The shaft 78 is joined to a center portion of the support roll 74 on both end surfaces of the support roll 74 in the axis direction of the support roll 74. The shaft 78 passes through the belt meandering suppression member guide 76 and is extended outwardly in the axis direction of the support roll 74.

The support roll 74 contacts the inner circumference surface of the endless belt 60 along with other support rolls and has a function to apply tension and maintain as it is. The support roll 74 includes a cylindrical member 74A and a lid member 74B. The cylindrical member 74A has openings on both ends of the cylindrical member 74A in an axis direction thereof. The lid member 74B closes the openings. Examples of a formation material of the support roll 74 include aluminium.

A high friction material layer 74C is provided on an outer circumference surface of the support roll 74 in order to prevent the belt from slipping when a load is applied to the endless belt. For example, an enveloping layer (from 5 μm to 50 μm and preferably approximately 25 μm) formed of polyurethane is applied as the high friction material layer 74C.

The belt meandering suppression member guide 76 is a member that contacts the belt meandering suppression member 64 and restrains movement of the endless belt 60 in the width direction of the endless belt 60. The belt meandering suppression member guide 76 includes, for example, a small diameter portion 76A and a large diameter portion 76B. The large diameter portion 76B is provided on the support roll 74 side of the small diameter portion 76A. The small diameter portion 76A and the large diameter portion 76B are integrally formed by using a truncated conical portion between the small diameter portion 76A and the large diameter portion 76B. The small diameter portion 76A and the large diameter portion 76B are configured to be joined to each other with the same axis. The belt meandering suppression member guide 76 is provided in such a manner that the shaft 78 which is the same as an axis of the support roll 74 passes through the belt meandering suppression member guide 76. It is preferable that a resin material having a slippery surface and a good sliding property is used as a formation material of the belt meandering suppression member guide 76, and for example, polyacetal is used.

In the exemplary embodiment, as illustrated in FIG. 3, an inner side surface of the belt meandering suppression member 64 contacts the truncated conical portion that joins the small diameter portion 76A and the large diameter portion 76B and thus movement of the endless belt 60 in the axis direction of the endless belt 60 is restrained.

In a structure illustrated in FIG. 3, the belt meandering suppression member guides 76 are disposed on both end portion sides of the support roll 74 in the axis direction of the support roll 74. However, when the belt meandering suppression member 64 is disposed on only one end portion of the belt base material 62 in the axis direction of the belt base material 62, the belt meandering suppression member guide 76 may be disposed on an end portion side of the support roll 74, which corresponds to the end portion of the endless belt 60 which the belt meandering suppression member 64 is disposed on.

The belt meandering suppression member guide 76 is not limited to the above-described configuration and may be configured with a columnar member or a cylindrical member in which grooves or notches are provided in a circumferential direction thereof and the belt meandering suppression member 64 is inserted into the grooves or the notches.

The guide attachment support roll 72 is disposed in the transfer unit to function as, for example, a tension roll, a steering roll, an idle roll, a driving roll, a backup roll, and the like. The rolls are provided depending on use. For example, as illustrated in FIG. 2, plural support rolls are arranged in the transfer unit according to the exemplary embodiment. However, all the rolls are not required to be the guide attachment support roll having the above-described configuration. At least one of support rolls may include the belt meandering suppression member guide 76.

Image Forming Apparatus

An image forming apparatus according to the exemplary embodiment will be described below. The image forming apparatus according to the exemplary embodiment includes an electrophotographic photoreceptor, a charging unit, an electrostatic latent image forming unit, a developing unit, and a transfer unit. The charging unit makes a surface of the electrophotographic photoreceptor to be charged. The electrostatic latent image forming unit forms an electrostatic latent image on the charged surface of the electrophotographic photoreceptor. The developing unit develops the electrostatic latent image formed on the surface of the electrophotographic photoreceptor with a developer containing a toner to form a toner image. The transfer unit has the endless belt according to the exemplary embodiment and transfers the toner image formed on the surface of the electrophotographic photoreceptor to a surface of a recording medium through the endless belt.

The image forming apparatus according to the exemplary embodiment may include the endless belt according to the exemplary embodiment as a transfer belt. For example, the image forming apparatus according to the exemplary embodiment may be a monochrome image forming apparatus in which only a toner with a single color is accommodated in a developing device. In addition, the image forming apparatus according to the exemplary embodiment may be a color image forming apparatus which includes plural developing devices accommodating toners, each of which has a color different from each other and in which a toner image formed on a surface of the electrophotographic photoreceptor is primarily transferred to the endless belt which functions as an intermediate transfer member, in consecutive order, and toner images having colors different from each other are superimposed to form a color image.

As an example of the image forming apparatus according to the exemplary embodiment, an image forming apparatus that forms a color image by superimposing toner images which have colors different from each other will be described below.

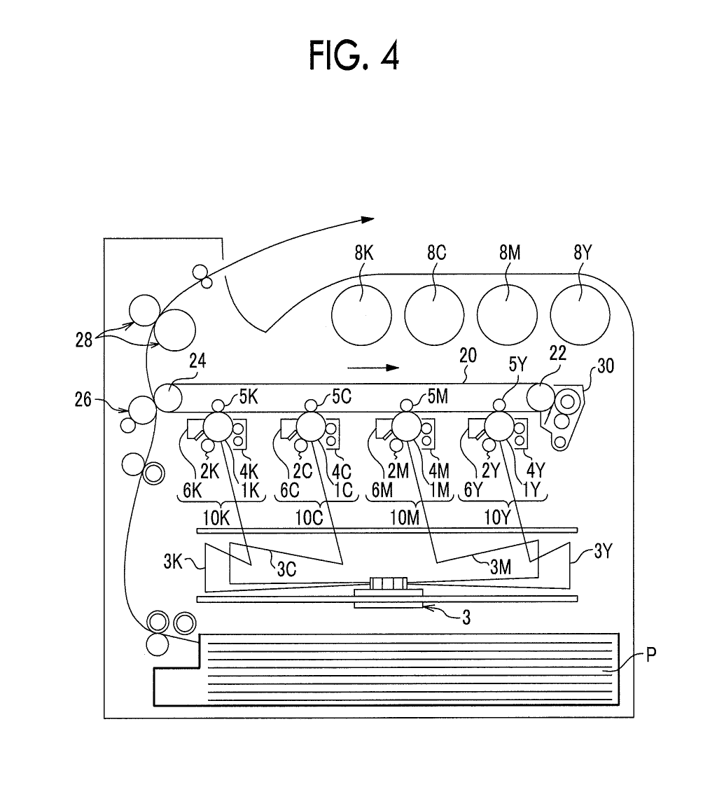

FIG. 4 illustrates a schematic configuration of an example of the image forming apparatus according to the exemplary embodiment. The image forming apparatus illustrated in FIG. 4 includes a first to a fourth image forming units 10Y, 10M, 10C, and 10K. The first to the fourth image forming units 10Y, 10M, 10C, and 10K are electrophotographic types and respectively output a yellow (Y) image, a magenta (M) image, a cyan (C) image, and a black (K) image based on color-separated image data. These image forming units (simply referred to as “unit” below) 10Y, 10M, 10C, and 10K are provided in parallel with each other at a predefined distance in a horizontal direction. These units 10Y, 10M, 10C, and 10K may be process cartridges detachable from an image forming apparatus.

An intermediate transfer belt 20 is disposed over the units 10Y, 10M, 10C, and 10K in FIG. 4. The endless belt according to the exemplary embodiment which functions as an intermediate transfer member passing by the units is used as the intermediate transfer belt 20. The intermediate transfer belt 20 is provided to be wound around a driving roll 22 and a support roll 24 and constitutes a transfer unit for the image forming apparatus so as to travel (rotate) in a direction from the first unit 10Y to the fourth unit 10K. The support roll 24 contacts an inner surface of the intermediate transfer belt 20, and the support roll 24 and the driving roll 22 are separately disposed in a direction from left to right in FIG. 4.

The belt meandering suppression member guide 76 is provided in each of the driving roll 22 and the support roll 24.

The support roll 24 is biased in a direction where the support roll 24 is separated from the driving roll 22 by a spring (not illustrated) and the like. Specific tension is applied to the intermediate transfer belt 20 wound around the support roll 24 and the driving roll 22. An intermediate transfer member cleaning device 30, facing the driving roll 22, is provided on an image holding member side of the intermediate transfer belt 20.

Toners of four colors which are yellow, magenta, cyan, and black are respectively supplied to developing devices (developing unit) 4Y, 4M, 4C, and 4K of the units 10Y, 10M, 10C, and 10K. The toners are respectively accommodated in toner cartridges 8Y, 8M, 8C, and 8K.

The first to fourth units 10Y, 10M, 10C, and 10K have configurations equivalent to each other. Accordingly, in the description, the first unit 10Y will be described representatively. The first unit 10Y is arranged on an upstream side in a travel direction of the intermediate transfer belt and forms a yellow image. The equivalent portions to that of the first unit 10Y are denoted by the reference numerals to which marks indicating magenta (M), cyan (C), and black (K) instead of a mark indicating yellow (Y) are attached and the descriptions of a second unit 10M, a third unit 10C, and the fourth unit 10K will be omitted.

The first unit 10Y includes a photoreceptor 1Y acting as an image holding member. A charging roll 2Y, an exposure device 3, a developing device (developing unit) 4Y, a primary transfer roll (primary transfer unit) 5Y, and a photoreceptor cleaning device (cleaning unit) 6Y are arranged in this order around the photoreceptor 1Y. The charging roll 2Y makes a surface of the photoreceptor 1Y to be charged to have a specific potential. The exposure device 3 exposes the charged surface with laser beam 3Y based on a color-separated image signal to form an electrostatic charge image. The developing device 4Y supplies a charged toner to the electrostatic charge image to develop the electrostatic charge image. The primary transfer roll 5Y transfers a developed toner image onto the intermediate transfer belt 20. The photoreceptor cleaning device 6Y removes the toner remaining on the surface of the photoreceptor 1Y after the primary transferring by using a cleaning blade.

The primary transfer roll 5Y is disposed inside the intermediate transfer belt 20 and provided at a position in which the primary transfer roll 5Y faces the photoreceptor 1Y. Bias power sources (not illustrated) are respectively connected to the primary transfer rolls 5Y, 5M, 5C, and 5K. The bias power sources are used for applying a primary transfer bias. Each of the bias power sources changes a transfer bias to be applied to the primary transfer roll under control of a control unit (not illustrated). The belt meandering suppression member guide 76 is also provided in each of the primary transfer rolls 5Y, 5M, 5C, and 5K.

An operation of forming a yellow image in the first unit 10Y will be described below. Ahead of the operation, the charging roll 2Y makes the surface of the photoreceptor 1Y to be charged to have a potential of approximately from −600 V to −800 V.

The photoreceptor 1Y is formed by stacking a photosensitive layer on a conductive (volume resistivity at 20° C.: not more than 1×10⁶ Ωcm) base material. The photosensitive layer has normally high resistance (resistance approximate to that of a general resin). However, the photosensitive layer has a property that resistivity at a portion to which the laser beams 3Y is applied is changed if the photosensitive layer is irradiated with the laser beam 3Y. The laser beam 3Y are output to the charged surface of the photoreceptor 1Y through the exposure device 3 in accordance with image data for yellow transmitted from the control unit (not illustrated). The laser beam 3Y are applied to a photosensitive layer on the surface of the photoreceptor 1Y and thus an electrostatic charge image having a yellow printing pattern is formed on the surface of the photoreceptor 1Y.

The electrostatic charge image refers to an image formed on the surface of the photoreceptor 1Y by charging and a so-called negative latent image. Resistivity at a portion of the photosensitive layer, to which the laser beam 3Y are applied decreases, charged charges of the surface of the photoreceptor 1Y flow, and charges at a portion to which the laser beam 3Y are not applied remain, thereby forming the negative latent image.

The electrostatic charge image formed on the photoreceptor 1Y in this manner is rotated up to a specific developing position in accordance with travel of the photoreceptor 1Y. The electrostatic charge image on the photoreceptor 1Y is changed to a visible image (developed image) at the developing position by the developing device 4Y.

For example, a yellow toner is accommodated in the developing device 4Y. The yellow toner is stirred in the developing device 4Y to make the yellow toner to be friction-charged. The friction-charged yellow toner has charges with the same polarity (negative polarity) as that of charged charges on the photoreceptor 1Y and the friction-charged yellow toner is held on a developer roll (developer holding member). The surface of the photoreceptor 1Y passes by the developing device 4Y and thus the yellow toner is electrostatically attached to a latent image portion at which charges on the surface of the photoreceptor 1Y are removed and the latent image is developed by the yellow toner. The photoreceptor 1Y on which a yellow toner image is formed is allowed to travel continuously at a specific speed and the toner image developed on the photoreceptor 1Y is transferred to a specific primary transfer position.

If the yellow toner image on the photoreceptor 1Y is carried to the primary transfer position, a specific primary bias is applied to the primary transfer roll 5Y and an electrostatic force directed to the primary transfer roll 5Y from the photoreceptor 1Y acts on the toner image. Then the toner image on the photoreceptor 1Y is transferred onto the intermediate transfer belt 20. The transfer bias applied at this time has a (+) polarity reversed to the polarity (−) of the toner. For example, the transfer bias is controlled to be approximately +10 μA in the first unit 10Y by control of the control unit (not illustrated).

The toner remaining on the photoreceptor 1Y is removed and collected in the cleaning device 6Y.

The primary transfer bias which is applied to the primary transfer rolls 5M, 5C, and 5K in the second unit 10M to the fourth unit 10K is also controlled similarly to the first unit.

In this manner, the intermediate transfer belt 20 to which the yellow toner image is transferred by the first unit 10Y passes by the second to fourth units 10M, 100, 10K in consecutive order and carried, and multi-transfer is performed by superimposing the toner images with colors.

The intermediate transfer belt 20 on which multi-transfer of toner images with four colors is performed while the intermediate transfer belt 20 passes through the first to the fourth units reaches a secondary transfer unit. The secondary transfer unit is configured by the intermediate transfer belt 20, the support roll 24 which contacts the inner surface of the intermediate transfer belt 20, a and secondary transfer roll (secondary transfer unit) 26 which is disposed on an image holding surface side of the intermediate transfer belt 20. A recording medium P is fed to a gap where the secondary transfer roll 26 and the intermediate transfer belt 20, which is pressed on the secondary transfer roll 26 through a supply mechanism at a specific timing, and a specific secondary transfer bias is applied to the support roll 24. The transfer bias applied at this time has (−) polarity the same as the polarity (−) of the toner. An electrostatic force directed to the recording medium P from the intermediate transfer belt 20 acts on the toner image and the toner image on the intermediate transfer belt 20 is transferred onto the recording medium P. The secondary transfer bias at this time is determined in accordance with resistance detected by a resistance detection unit (not illustrated) that detects resistance of a secondary transfer unit. The secondary transfer bias is voltage-controlled.

Then, the recording medium P is carried to a fixing device (fixing unit) 28 and the toner image is heated. The toner image in which colors are superimposed is melted and fixed onto the recording medium P. The recording medium P in which fixation of the color image is completed is transported to an exit unit and a series of the color image formation operation is ended.

The above-described image forming apparatus is configured in such a manner that plural toner images are superimposed through the intermediate transfer belt 20 and the superimposed toner image is transferred to the recording medium P. However, the image forming apparatus according to the exemplary embodiment is not limited thereto. For example, the image forming apparatus may be an image forming apparatus in which a monochrome toner image formed on the surface of the photoreceptor is transferred to a recording medium through the intermediate transfer belt 20.

### EXAMPLES

An exemplary embodiment using examples will be described below and the exemplary embodiment is not limited in any way by the examples.

### Example 1

### Manufacturing of Belt Base Material 1

Carbon black (SPECIAL Black 4, manufactured by Evonik Degussa Japan Co., Ltd.) is put in a polyimide solution (U imide KX, manufactured by Unitika Ltd./solid content concentration of 18% by weight) such that a weight ratio of solid content is 4% by weight. Dispersion processing (200 N/mm² and 5 passes) is performed with a jet mill disperser (GeanusPY: product manufactured by Genus Co., Ltd.).

The obtained carbon black dispersion polyamic acid solution is passed through a mesh of 20 μm made of stainless steel to remove foreign substances and carbon black aggregates. Vacuum deforming is performed for 15 minutes while stirring and coating liquid (solid content concentration: 21% by weight) for endless belt formation is prepared.

An outer surface of an aluminium pipe is coated with the prepared coating liquid and is rotated and dried for 30 minutes at 150° C.

Then, the aluminium pipe is put in an oven at 315° C. for one hour, and then the aluminium pipe is taken out from the oven. A resin film formed on the outer surface of the aluminium pipe is peeled off the pipe to obtain an endless belt base material having a thickness of 0.08 mm.

Manufacturing of Belt Meandering Suppression Member 1

A thermosetting urethane sheet (PU3 manufactured by Tigers Polymer Corp.) having a thickness of 1 mm is used as a material of the belt meandering suppression member to manufacture the belt meandering suppression member having a width of 5 mm. The length of the belt meandering suppression member is set to be attached to almost of the entire circumference of the inner circumference surface on one end portion of the endless belt.

Measurement of the Linear Thermal Expansion Coefficient of the Belt Base Material and the Belt Meandering Suppression Member

Linear thermal expansion coefficients of the manufactured belt base material and the belt meandering suppression member are measured by the above-described method.

Measurement of Tensile Stress at 300% Elongation

The tensile stress in the manufactured belt meandering suppression member at 300% elongation is measured by the above-described method.

Manufacturing of Transfer Belt 1

The manufactured belt meandering suppression member is coated with Super-XNo8008 (made by Cemedine Co., Ltd.), as an elastic adhesive, which is formed of acrylic denatured silicone polymer as a main component, to provide a thickness of 20 μm. Then, the belt meandering suppression member is disposed on an inner surface of one end portion of the belt base material in the width direction of the belt base material and pressure of 0.03 MPa is applied to manufacture a belt meandering suppression member attachment transfer belt 1.

### Example 2

### Manufacturing of Transfer Belt 2

The belt meandering suppression member attachment transfer belt 2 is manufactured similarly to Example 1 except that the material of the belt meandering suppression member in Example 1 is changed to polyester ether elastomer (manufactured by Tsuchiya Co., Ltd.).

### Example 3

### Manufacturing of Belt Base Material 2

Carbon black (SPECIAL Black 5, manufactured by Evonik Japan Co., Ltd.) is put in a polyimide solution (U imide TX, manufactured by Unitika Ltd./solid content concentration of 18% by weight) such that a weight ratio of solid content becomes 4% by weight, and the carbon black and the polyimide solution are mixed.

The obtained carbon black dispersion polyamic acid solution is passed through a mesh of 20 μm made of stainless steel to remove foreign substances and carbon black aggregates. Vacuum deforming is performed for 15 minutes while stirring, and coating liquid (solid content concentration: 21% by weight) for endless belt formation is prepared.

An outer surface of an aluminium pipe is coated with the prepared coating liquid and is rotated and dried for 30 minutes at 150° C.

Then, the aluminium pipe is put in an oven at 315° C. for one hour, and then the aluminium pipe is taken out from the oven. A resin film formed on the outer surface of the aluminium pipe is peeled off the pipe to obtain an endless belt base material having a thickness of 0.08 mm.

Manufacturing of Transfer Belt 3

The belt meandering suppression member attachment transfer belt 3 is manufactured similarly to Example 1 except that the belt base material 1 in Example 1 is changed to the belt base material 2.

### Example 4

### Manufacturing of Belt Base Material 3

Carbon black (FW1, manufactured by Degussa Ltd.) is put in solvent soluble type polyamideimide resin (HPC-9000, manufactured by Hitachi Chemical Co., Ltd, solid content concentration of 18% by weight, and solvent: n-methyl-2-pyrrolidone) such that a weight ratio of solid content is 4% by weight. Dispersion processing (200 N/mm² and 5 passes) is performed with a jet mill disperser (GeanusPY: product manufactured by Genus Co., Ltd.).

The obtained carbon black dispersion polyamic imide solution is passed through a mesh of 20 μm made of stainless steel to remove foreign substances and carbon black aggregates. Vacuum deforming is performed for 15 minutes while stirring, and coating liquid (solid content concentration: 21% by weight) for endless belt formation is prepared.

An outer surface of an aluminium pipe is coated with the prepared coating liquid and is rotated and dried for 30 minutes at 150° C.

Then, the aluminium pipe is put in an oven at 315° C. for one hour, and then the aluminium pipe is taken out from the oven. A resin film formed on the outer surface of the aluminium pipe is peeled off the pipe to obtain an endless belt base material having a thickness of 0.08 mm.

Manufacturing of Transfer Belt 4

The belt meandering suppression member attachment transfer belt 4 is manufactured similarly to Example 2 except that the belt base material 1 in Example 2 is changed to the belt base material 3.

### Comparative Examples 1 to 9

As shown in Table 1, the belt meandering suppression member attachment transfer belts 5 to 13 are manufactured similarly to Example 1 except that the belt base material and the belt meandering suppression member are changed.

In Table 1, materials used for manufacturing the belt base material and the belt meandering suppression member are as follows.

Polyimide KX: (U imide KX, manufactured by Unitika Ltd.)

polyimide TX: (U imide TX, manufactured by Unitika Ltd.)

polyamideimide: (HPC-9000, manufactured by Hitachi Chemical Co., Ltd)

TPEE: (polyester ether elastomer, manufactured by Tsuchiya Co., Ltd.)

PU1: (thermosetting urethane, manufactured by Tigers Polymer Corp.)

PU2: (thermosetting urethane, manufactured by Tigers Polymer Corp.)

PU3: (thermosetting urethane, manufactured by Tigers Polymer Corp.)

TABLE 1

| | | | | | Belt meandering suppression member | | | | |
|---|---|---|---|---|---|---|---|---|---|
| | | Material of belt | | | | | | Tensile strength when | Diferrence between |
| | | | | Linear thermal | | | Linear thermal | belt meandering | linear thermal |
| | | | | expansion | | | expansion | suppression member is | expansion coefficient |
| | Transfer | | | coefficient A | | Resin | coefficient B | extended to 300% | (A − B) |
| | belt | No. | Resin material | (×10⁻⁵/° C.) | No. | material | (×10⁻⁵/° C.) | (MPa) | (×10⁻⁵/° C.) |
| Example 1 | 1 | 1 | Polyimide KX | 32 | 1 | PU3 | 20 | 21.2 | 12 |
| Example 2 | 2 | 1 | Polyimide KX | 32 | 2 | TPEE | 22 | 6.0 | 10 |
| Example 3 | 3 | 2 | Polyimide TX | 19 | 1 | PU3 | 20 | 21.2 | −1 |
| Example 4 | 4 | 3 | Polyamideimide | 42 | 2 | TPEE | 22 | 6.0 | 20 |
| Comparative | 5 | 1 | Polyimide KX | 32 | 3 | PU1 | 29 | 3.2 | 3 |
| Example 1 | | | | | | | | | |
| Comparative | 6 | 1 | Polyimide KX | 32 | 4 | PU2 | 22 | 3.6 | 10 |
| Example 2 | | | | | | | | | |
| Comparative | 7 | 2 | Polyimide TX | 19 | 3 | PU1 | 29 | 3.2 | −10 |
| Example 3 | | | | | | | | | |
| Comparative | 8 | 2 | Polyimide TX | 19 | 4 | PU2 | 22 | 3.6 | −3 |
| Example 4 | | | | | | | | | |
| Comparative | 9 | 2 | Polyimide TX | 19 | 5 | TPEE | 22 | 6.0 | −3 |
| Example 5 | | | | | | | | | |
| Comparative | 10 | 3 | Polyamideimide | 42 | 3 | PU1 | 29 | 3.2 | 13 |
| Example 6 | | | | | | | | | |
| Comparative | 11 | 3 | Polyamideimide | 42 | 4 | PU2 | 22 | 3.6 | 20 |
| Example 7 | | | | | | | | | |
| Comparative | 12 | 3 | Polyamideimide | 42 | 1 | PU3 | 20 | 21.2 | 22 |
| Example 8 | | | | | | | | | |

Evaluation of Color Deviation

Transfer belts manufactured in Examples and Comparative Examples are applied to a modified machine (ApeosPortlV C5575, manufactured by Fuji Xerox Co., Ltd.) as an intermediate transfer belt and 50000 A4 horizontal sheets are printed under a high temperature and high humidity circumstance of 30° C. and 85% RH. The extent of color deviation in the 50000th printed paper is confirmed by a microscope and evaluated in accordance with the following standards.

A: the maximum value of color deviation is equal to or less than 50 μm

B: the maximum value of color deviation is more than 50 μm and 100 μm or less

C: the maximum value of color deviation is more than 100 μm.

Separation and deformation of the belt meandering suppression members are visually evaluated in accordance with the following standards.

Separation of Belt Meandering Suppression Member

A: no separation

B: separation on an end portion (less than 5 mm)

C: separation of equal to or more than 5 mm

Deformation of Belt Meandering Suppression Member

A: no deformation

B: slight deformation (less than 5 mm)

C: deformation (equal to or more than 5 mm)

TABLE 2

| | | Separation | Deformation |
|---|---|---|---|
| | | of belt | of belt |
| | | meandering | meandering |
| | Color | suppression | suppression |
| | deviation | member | member |
| Example 1 | A | A | A |
| Example 2 | A | A | B |
| Example 3 | A | A | A |
| Example 4 | A | B | B |
| Comparative Example 1 | C | A | C |
| Comparative Example 2 | C | A | C |
| Comparative Example 3 | C | A* | C |
| Comparative Example 4 | C | A* | C |
| Comparative Example 5 | C | A* | B |
| Comparative Example 6 | C | A | C |
| Comparative Example 7 | C | B | C |
| Comparative Example 8 | B | C | A |

In Comparative Examples 3 to 5 of “A*” relating to separation of the belt meandering suppression member, the end portion of the transfer belt has a trumpet shape, and thus there is a non-contact location of the transfer belt and the belt meandering suppression member.

If the value obtained by subtracting the linear thermal expansion coefficient of the belt meandering suppression member from the linear thermal expansion coefficient of the belt base material is more than 20×10⁻⁵/° C., separation of the belt meandering suppression member estimated resulting from a difference between the linear thermal expansion coefficients occurs. When the value obtained by subtracting the linear thermal expansion coefficient of the belt meandering suppression member from the linear thermal expansion coefficient of the belt base material is less than −1×10⁻⁵/° C., the end portion of the transfer belt has a trumpet shape, and thus the belt meandering suppression member does not function and color deviation occurs remarkably.

When the tensile stress is less than 5 MPa at 300% elongation with respect to the belt meandering suppression member, color deviation occurs due to deformation of the belt meandering suppression member.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An endless belt comprising:
an endless belt base material; and
a belt meandering suppression member that has a belt shape and is disposed in a circumferential direction of at least one end portion of the belt base material in a width direction,
wherein a value obtained by subtracting a linear thermal expansion coefficient of the belt meandering suppression member from a linear thermal expansion coefficient of the belt base material is from −1×10⁻⁵/° C. to 20×10⁻⁵/° C., and
a tensile stress of the belt meandering suppression member at a 300% elongation is equal to or more than 5 MPa.

2. The endless belt according to claim 1,
wherein the belt base material contains a resin.

3. The endless belt according to claim 2,
wherein the resin is polyimide or polyamideimide resin.

4. The endless belt according to claim 1,
wherein the value obtained by subtracting the linear thermal expansion coefficient of the belt meandering suppression member from the linear thermal expansion coefficient of the belt base material is from −1×10⁻⁵/° C. to 15×10⁻⁵/° C.

5. The endless belt according to claim 1,
wherein the value obtained by subtracting the linear thermal expansion coefficient of the belt meandering suppression member from the linear thermal expansion coefficient of the belt base material is from −0×10⁻⁵/° C. to 10×10⁻⁵/° C.

6. The endless belt according to claim 1,
wherein the belt meandering suppression member is configured to contain polyester ether elastomer.

7. The endless belt according to claim 1,
wherein the tensile stress of the belt meandering suppression member at a 300% elongation is from 5 MPa to 30 MPa.

8. The endless belt according to claim 1,
wherein the tensile stress of the belt meandering suppression member at a 300% elongation is from 5 MPa to 20 MPa.

9. A transfer unit comprising:
the endless belt according to claim 1; and
a plurality of rolls that rotatably support the endless belt, wherein at least one roll contacts with a belt meandering suppression member of the endless belt and suppresses movement of the endless belt in a width direction of the endless belt.

10. An image forming apparatus comprising:
an electrophotographic photoreceptor;
a charging unit that charges a surface of the electrophotographic photoreceptor;
an electrostatic latent image forming unit that forms an electrostatic latent image on a charged surface of the electrophotographic photoreceptor;
a developing unit that develops the electrostatic latent image formed on the surface of the electrophotographic photoreceptor by using a developer containing a toner to form a toner image; and
a transfer unit that includes the endless belt according to claim 1 and transfers the toner image formed on the surface of the electrophotographic photoreceptor to a surface of a recording medium through the endless belt.
